(19) United States
(12) Patent Application Publication
(10) Pub. No.: US 2005/0269147 A1
(43) Pub. Date: Dec. 8, 2005

(54) Support structure of power transmission shaft in differential gear for vehicle

(75) Inventor: Eiji Mito, Aki-gun (JP)

Correspondence Address: NIXON PEABODY, LLP, 401 9TH STREET, NW, SUITE 900, WASHINGTON, DC, 20004-2128, US

(73) Assignee: MAZDA MOTOR CORPORATION, Aki-gun (JP)

(21) Appl. No.: 11/135,296

(22) Filed: May 24, 2005

(30) Foreign Application Priority Data
Jun. 3, 2004 (JP) 2004-166292

(51) Int. Cl. F16H 57/02

(52) U.S. Cl. 180/248

(57) ABSTRACT

There is provided the anti-loosening spacer between the screw lock nut and the inner race of the first bearing for drive pinion, such that it is moved forward by a rotation of the screw lock nut, and there can exist the specified magnitude of backlash in the rotational direction between the anti-loosening spacer and the drive pinion shaft at the beginning of the rotation of the screw lock nut, and the specified magnitude of backlash can be eliminated according to the rotation of the screw lock nut. Accordingly, the screw lock nut can be properly prevented from being loosened by this locked spacer.

### BACKGROUND OF THE INVENTION

The present invention relates to a support structure of a power transmission shaft in a differential gear for a vehicle.

Conventionally, the following support structure of a power transmission shaft is known (see, for example, Japanese Patent Laid-Open Publication Nos. 2002-147569 and 2003-74598). Namely, there are provided the power transmission shaft which is equipped with an input portion for receiving a power at one end thereof and a drive gear for transmitting the power at the other end thereof, a differential carrier on which the power transmission shaft is supported, first and second bearings to rotatably support the power transmission shaft on the differential carrier, the first and second bearings being provided in serial order from the one end of the power transmission, and a screw lock nut which is disposed on the power transmission shaft.

Herein, the above-described screw lock nut functions so as to apply a preload to the first and second bearings, thereby supporting the power transmission shaft stably. As a result, noises and breakage of the bearings can be prevented properly.

Generally, since a large rotational torque from an engine is transmitted to the above-described power transmission shaft, a reaction force toward the above-described one end of the power transmission shaft is generated at the first and second bearings which support the power transmission shaft. This reaction force functions so as to cause the screw lock nut pressing the bearings to be rotated and loosened.

Accordingly, in the event that the larger rotational torque is transmitted to the power transmission shaft, the larger fastening torque needs to be applied to the screw lock nut to prevent the lock nut from being loosened properly.

However, since there is a limit to a face pressure the screw lock nut can receive, too large fastening torque might cause a problem of breakage of the screw lock nut.

Also, applying such a large fastening torque to the screw lock nut would need some particular equipments which is necessary for such large fastening torque.

Further, the application of large fastening torque results in the first and second bearings being pressed axially greatly, and thereby the rotational friction of the power transmission shaft would increase inappropriately. This might cause another problem of deterioration of durability of the first and second bearings.

### SUMMARY OF THE INVENTION

The present invention has been devised in view of the above-described problems, and an object of the present invention is to prevent the screw lock nut from being loosened properly, without increasing the fastening torque of the screw lock nut improperly, even if the rotational torque being transmitted to the power transmission shaft is considerably large.

This object is solved by a support structure of a power transmission shaft according to the present invention. Preferred embodiments of the present invention are subject of the dependent claims.

According to the present invention, there is provided a support structure of a power transmission shaft in a differential gear for a vehicle, comprising a power transmission shaft which is equipped with an input portion for receiving a power at one end thereof and a drive gear for transmitting the power at the other end thereof, a differential carrier on which the power transmission shaft is supported, first and second bearings to rotatably support the power transmission shaft on the differential carrier, the first and second bearings being provided in serial order from the one end of the power transmission, a screw lock nut which is disposed on the power transmission shaft, an anti-loosening spacer which is disposed on the power transmission shaft between the screw lock nut and an inner race of the first bearing, the anti-loosening spacer being configured so as to be pressed and moved forward on the power transmission shaft by a rotation of the screw lock nut. Further, the anti-loosening spacer includes a tooth and groove portion which is formed at an inner periphery thereof, the power transmission shaft includes a tooth and grove portion which is formed at an outer periphery thereof so as to engage with the tooth and groove portion of the anti-loosening spacer, and a tooth line of the tooth and groove portion of the anti-loosening spacer and a tooth line of the tooth and groove portion of the power transmission shaft are configured so as to extend in a substantially axial direction of the power transmission shaft but with a specified difference in angle thererbetween, whereby there can exist a specified magnitude of backlash in a rotational direction between the anti-loosening spacer and the power transmission shaft at the beginning of the rotation of the screw lock nut, and the specified magnitude of backlash can be eliminated according to the rotation of the screw lock nut.

According to this structure, as the anti-loosening spacer is moved forward by the rotation of the screw lock nut, the backlash between the anti-loosening spacer and the power transmission shaft, which has existed at the beginning, is eliminated substantially. Namely, the anti-loosening spacer engages with the power transmission shaft firmly, and thereby the anti-loosening spacer can be locked firmly. As a result, the screw lock nut can be prevented from being loosened properly by this locked spacer.

According to a preferred embodiment of the present invention, an angle of chamfer formed at an end corner of the tooth and groove portion of the anti-loosening spacer is configured so as to be smaller than that formed at an end corner of the tooth and groove portion of the power transmission shaft.

Accordingly, since as the anti-loosening spacer is moved forward by the rotation of the screw lock nut, the chamfered end portion of the tooth and groove portion of the anti-loosening spacer contacts and starts sliding smoothly on the chamfered end portion of the tooth and groove portion of the power transmission shaft, their teeth and grooves engage with each other smoothly.

According to another preferred embodiment of the present invention, a hardening treatment is applied to a face of the anti-loosening spacer which contacts the inner race of the first bearing.

Accordingly, since the contacting face of the anti-loosening spacer with the inner race of the first bearing is hardened by the hardening treatment, the contact face can be prevented properly from being worn away or dented by a large pressure generating thereat.

According to further another preferred embodiment of the present invention, an interference of insertion pressure between the inner race of the first bearing and the power transmission shaft is configured so as to be smaller than that of insertion pressure between an inner race of the second bearing and the power transmission shaft.

Accordingly, since the interference of insertion pressure between the inner race of the first bearing and the power transmission shaft is smaller than that of insertion pressure between the inner race of the second bearing and the power transmission shaft, the frictional resistance generating between the inner race of the first bearing and the power transmission shaft can be reduced, and thereby the fastening torque of the screw lock nut can be reduced, compared with the case where both the interference are configured so as to be similar.

According to further another preferred embodiment of the present invention, the differential gear for a vehicle comprises a wet multi-plate clutch device to control a distribution ratio of drive power between front wheels and rear wheels of the vehicle, and a power from the wet multi-plate clutch device is transmitted to the input portion of the transmission shaft.

Accordingly, there can be provided a proper support structure of the power transmission shaft in the differential gear equipped with the wet multi-pale clutch device for a four-wheel driving vehicle.

Other features, aspects, and advantages of the present invention will become apparent from the following description which refers to the accompanying drawings.

### BRIEF DESCRIPTION OF THE DRAWINGS

FIG. 1 is a plan sectional view illustrating a differential gear with a support structure of a power transmission shaft according to an embodiment of the present invention.

FIG. 2 is an enlarged sectional view of an anti-loosening spacer.

FIG. 3 is an enlarged side view of part of a drive pinion shaft.

FIG. 4 is an explanatory diagram of a backlash existing between the anti-loosening spacer and the drive pinion shaft.

### DETAILED DESCRIPTION OF THE INVENTION

Hereinafter, an embodiment of the present invention will be described referring to the accompanying drawings. Herein, the following discloses an essentially preferred embodiment, and the present invention should not to be limited to this embodiment described specifically here in a scope of its application and use.

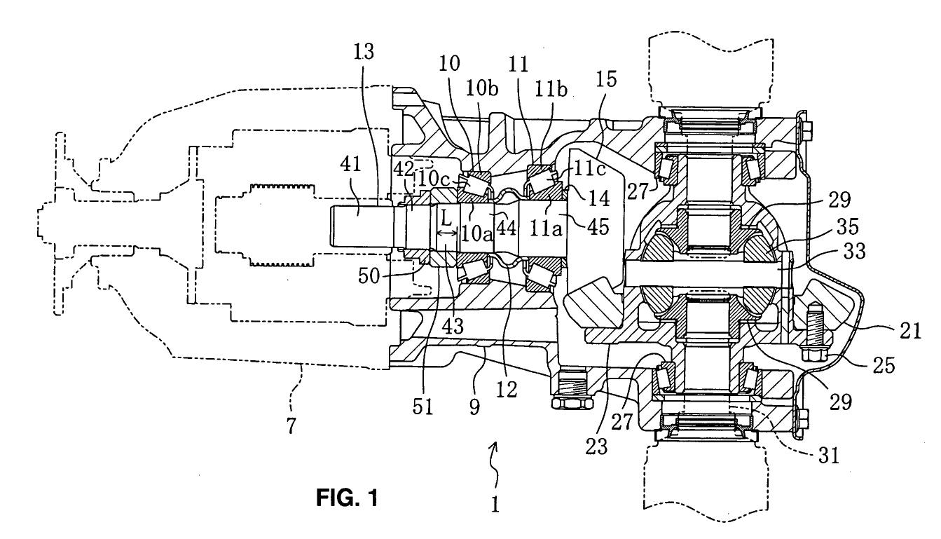

FIG. 1 illustrates a differential gear 1 of rear wheels for a four-wheel driving vehicle. A wet multi-plate type of electromagnetic clutch device 7 (illustrated by a two-dotted broken line in FIG. 1) is coupled to the front of the differential gear 1. A drive power of a vehicle engine is transmitted to the electromagnetic clutch device 7 via a propeller shaft, not illustrated, and the electromagnetic clutch device 7 controls a distribution ratio of the drive power to front wheels and the rear wheels of the vehicle.

The differential gear 1 is enclosed by a differential carrier 9 which extends in a substantially longitudinal direction of the vehicle. Some lubricating oil is kept within the differential carried 9. First and second bearings for drive pinions 10 and 11, as first and second bearings, are provided, in serial order from the front, at a front inner portion of the differential carrier 9. These first and second bearings for drive pinions 10 and 11 rotatably support a drive pinion shaft 13 which transmits the rotation and torque from the electromagnetic clutch device 7. The drive pinion shaft 13 is equipped with a spline 41, as an input portion for receiving the power, at one end thereof and a drive pinion gear 15, as a drive gear for transmitting the power, at the other end thereof. The spline 41 is coupled to a rotational shaft (not illustrated) of the electromagnetic clutch device 7 via a spline coupling.

Also, a ring gear 21 with an axis extending in a substantially vehicle width direction is rotatably supported at a rear inner portion of the differential carrier 9. The above-described drive pinion shaft 13 is so as to be placed being offset below from the ring gear 21, and the drive pinion gear 15 engages with the ring gear 21. Accordingly, the rotation and torque from the electromagnetic clutch 7 is transmitted to the ring gear 21, changing the direction by a substantially right angle.

A differential gear case 23 is integrally connected with the ring gear 21 via a bolt 25. This differential gear case 23 is rotatably supported by right and left side bearing 27 which are provided at the differential carrier 9. And, right and left side gears 29 are disposed in the differential gear case 23, and these side gears 29 are coupled to drive shafts 31 for driving the right and left vehicle wheels, respectively. The side gears 29 engage with differential pinion gears 35 which are fixed to a differential pinion shaft 33. Accordingly, in the event that there occurs a difference in rotational speed between the right and left vehicle wheels, the differential is applied to the right and left drive shafts 31, thereby preventing slip of tires properly.

Between the above-described spline 41 and the drive pinion gear 15 on the drive pinion shaft 13, are provided, in serial order from the side of spline 41, a screw portion 42 which has a greater diameter than the spline 41, a serration portion 43 which has a greater diameter than the screw portion 42, a first-bearing contact face 44 which has a greater diameter than the serration portion 43 and is for the first bearing for drive pinion 10, a second-baring contact face 45 which has a greater diameter than the first-bearing contact face 44 and is for the second bearing for drive pinion 11.

Between the first bearing for drive pinion 10 and the second bearing for drive pinion 11, is provided a distance piece (spacer) 12. This distance piece 12 is made of a plastically deformed spacer which can generate a reaction force against even a small magnitude of displacement (torsion). Axial both ends of the distance spice 12 respective contact inner races 10a and 11a of the above-described first and second bearings for drive pinions 10 and 11.

Also, a ring shim 14 is provided between the inner race 11a of the second bearing for drive pinion 11 and the drive pinion gear 15. This shim 14 adjusts a clearance existing between the inner race 11a and the drive pinion gear 15, and thus a tooth contact between the drive pinion gear 15 and the ring gear 21 can be properly adjusted by this shim 14.

Also, an interference of insertion pressure between the inner race 10a of the first bearing for drive pinion 10 and the first-bearing contact face 44 is adjusted so as to be smaller than that between the inner race 11a of the second bearing for drive pinion 11 and the second-bearing contact face 45.

A screw lock nut 50 is provided on the screw portion 42 of the drive pinion shaft 13, and this lock nut 50 is provide so as to apply a preload to the first and second bearings for drive pinions 10 and 11 by a rotation of this lock nut 50.

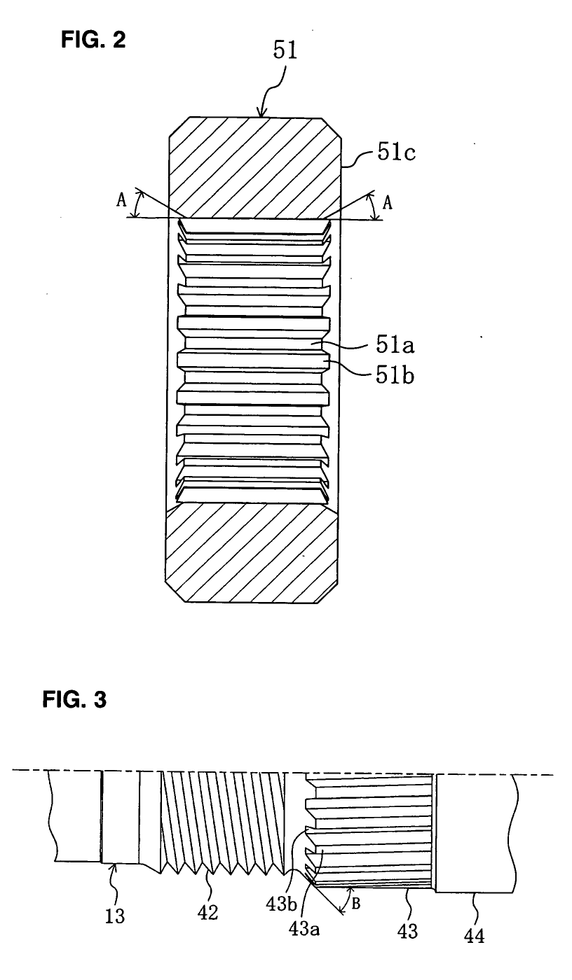

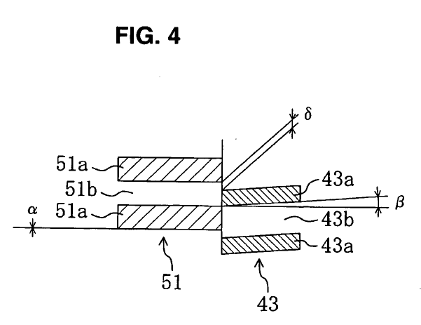

Next, there is provided a cylindrical anti-loosening spacer 51, which is one of features of the present invention, between the screw lock nut 50 and the first bearing for drive pinion 10. As illustrated in FIG. 2, this anti-loosening spacer 51 includes teeth 51a and grooves 51b, as a tooth and groove portion of the anti-loosening spacer 51, which are formed at an inner periphery thereof and a tooth line of which extend in a substantially axial direction thereof. Meanwhile, as illustrated in FIG. 3, teeth 43a and groves 43b, as a tooth and groove portion of the drive pinion shaft 13, are formed on the outer periphery of the serration portion 43 of the drive pinion shaft 13, a tooth line of which extend in the substantially axial direction, so as to engage with the above-described teeth and grooves 51a and 51b of the anti-loosening spacer 51. As illustrated in the enlarged view of FIG. 4, there exists a specified magnitude of backlash δ in the rotational direction between the teeth and grooves 51a and 51b of the anti-loosening spacer 51 and the teeth and grooves 43a and 43b of the drive pinion shaft 13 at the beginning of a rotation of the screw lock nut 50.

Specifically, the tooth line of the teeth and grooves 51a and 51b of the anti-loosening spacer 51 extends with a specified angle α with respect to the axial direction, whereas the tooth line of the teeth and grooves 43a and 43b of the drive pinion shaft 13 extends with a specified angle β with respect to the axial direction. Herein, both angles α and β are different in magnitude from each other (i.e., α≠β). In the present embodiment, the angle α is set at approximately 0 degree (α=0°) and β is set at approximately 22 minutes (β=22′), with approximately 12.6 mm of an engagement length L (see FIG. 1) of the teeth and grooves 51a and 51b and the teeth and grooves 43a and 43b. Herein, in the event that the engagement length L is set at a shorter one, it is preferable that the angle β may be set at a greater one in case of the angle α remaining at 0 degree (a=0°).

Thus, there is a difference in angle magnitude between the angle α and the angle β. Accordingly, the backlash δ becomes smaller as the anti-loosening spacer 51 is moved forward in the axial direction by the rotation of the screw lock nut 50. And, finally, when the screw lock nut 50 comes to a point of a specified magnitude of the engagement length L, the backlash δ is eliminated substantially.

Also, as illustrated in FIG. 2, there are provided chamfer at both end corners of the above-described teeth and grooves 51a and 51b of the anti-loosening spacer 51. Meanwhile, as illustrated in FIG. 3, there are also provided chamfer at one end corner, which is located at the side of the screw portion 42, of the teeth and grooves 43a and 43b of the drive pinion shaft 13. Herein, an angle A of the chamfer formed at the anti-loosening spacer 51 is configured so as to be smaller than an angle β of the chamber formed at the drive pinion shaft 13 (A<B). In the present embodiment, for example, the angle A is set at approximately 35 degrees (35°) and the angle β is set at approximately 45 degrees (45°). Herein, in the event that the chamfer is provided at the both end corners of the anti-loosening spacer 51 as illustrated, the spacer 51 can be installed from any side, resulting in an easy installation.

Also, a heat hardening treatment is applied to the faces (both sides) 51c of the anti-loosening spacer 51 which is supposed to contact the inner race 10a of the first bearing for drive pinion 10.

Assembling Process—

Hereinafter, an assembling process of the support structure of the drive pinion shaft 13 according to the present embodiment will be described.

First, there is provided the shim 14 which is selected for properly adjusting the tooth contact between the drive pinion gear 15 and the ring gear 21.

Next, after the ring shim 14 has been inserted into the drive pinion shaft 13 from the side of spline 41 so as to contact the drive pinion gear 15, the inner race 11a of the second bearing for drive pinion 11 is pushed in and fixed.

Subsequently, the outer races 10b and 11b of the first and second bearings for drive pinions 10 and 11 are pushed in and fixed.

Then, rollers 11c are placed on the inner race 11a of the second bearing for drive pinion 11 which has been fixed on the drive pinion shaft 13, and subsequently the drive pinion shaft 13 is inserted into the differential carrier 9 from the rear side (the right in FIG. 1).

Next, the distance piece 12, and the inner race 10a and the rollers 10c of the first bearing for drive pinion 10 are respectively inserted in order into the drive pinion shaft 13 from the front side (the left in FIG. 1) of the differential carrier 9.

After that, the anti-loosening spacer 51 and the screw lock nut 50 are inserted in order into the drive pinion shaft 13.

Then, the screw lock nut 50 is pushed toward the drive pinion gear 15 so that the screw portion of the screw lock nut 50 can overlap a little with the screw portion 42 of the drive pinion shaft 13.

Finally, the screw lock nut 50 is fastened by a lock-nut fastening device with an appropriate torque.

Herein, as the anti-loosening spacer 51 is moved forward by the rotation of the screw lock nut 50, the teeth and grooves 51a and 51b of the anti-loosening spacer 51 and the teeth and grooves 43a and 43b of the drive pinion shaft 13 start engaging with each other. Namely, the chamfered end portion of the teeth and grooves 51a and 51b contacts and starts sliding smoothly on the chamfered end portion of the teeth and grooves 43a and 43b.

As the anti-loosening spacer 51 further advances according to the additional rotation of the screw lock nut 50, the teeth and grooves 51a and 51b gradually engage with the teeth and grooves 43a and 43b because there exists the specified difference in angle between the both tooth lines of the teeth and grooves 51a and 51b and the teeth and grooves 43a and 43b.

And, after the anti-loosening spacer 51 has advanced furthermore by the rotation of the screw lock nut 50, the backlash δ between the anti-loosening spacer 51 and the drive pinion shaft 13, which existed at the beginning, vanishes substantially.

A further rotation of the screw lock nut 50 from this point provides a stiff engagement between the anti-loosening spacer 51 and the drive pinion shaft 13, and thereby the anti-loosening spacer 51 can be locked firmly. As a result, the screw lock nut 50 can be prevented from being loosened by this locked spacer 51.

As described, according to the present embodiment, there are provided the drive pinion shaft 13 which is equipped with the spline 41 for receiving the power at one end thereof and the drive pinion gear 15 for transmitting the power at the other end thereof, the differential carrier 9 on which the drive pinion shaft 13 is supported, the first and second bearings for drive pinion 10 and 11 to rotatably support the drive pinion shaft 13 on the differential carrier 9, the first and second bearings for drive pinion 10 and 11 being provided in serial order from the one end of the drive pinion shaft 13, the screw lock nut 50 which is disposed on the drive pinion shaft 13, and the anti-loosening spacer 51 which is disposed on the drive pinion shaft 13 between the screw lock nut 50 and the inner race 10a of the first bearing for drive pinion 10, the anti-loosening spacer 51 being configured so as to be pressed and moved forward on the drive pinion shaft 13 by the rotation of the screw lock nut 50. Further, the anti-loosening spacer 51 includes the teeth and grooves 51a and 51b which are formed at the inner periphery thereof, the drive pinion shaft 13 includes the teeth and grooves 43a and 43b which are formed at the outer periphery of the serration portions 43 thereof so as to engage with the teeth and grooves 51a and 51b of the anti-loosening spacer 51, and the tooth line of the teeth and grooves 51a and 51b of the anti-loosening spacer 51 and the tooth line of the teeth and grooves 43a and 43b of the drive pinion shaft 13 are configured so as to extend in the substantially axial direction of the drive pinion shaft 13 but with the specified difference in angle thererbetween, whereby there can exist the specified magnitude of backlash δ in the rotational direction between the anti-loosening spacer 51 and the drive pinion shaft 13 at the beginning of the rotation of the screw lock nut 50, and the specified magnitude of backlash 6 can be eliminated according to the rotation of the screw lock nut 50.

According to this structure, as the anti-loosening spacer 51 is moved forward by the rotation of the screw lock nut 50, the backlash δ between the anti-loosening spacer 51 and the drive pinion shaft 13, which has existed at the beginning, is eliminated substantially. Namely, the anti-loosening spacer 51 engages with the drive pinion shaft 13 firmly, and thereby the anti-loosening spacer 51 can be locked firmly. As a result, the screw lock nut 50 can be prevented from being loosened by this locked spacer 51.

Further, the angle of chamfer formed at the end corner of the teeth and grooves 51a and 51b of the anti-loosening spacer 51 is configured so as to be smaller than that formed at the end corner of the teeth and grooves 43a and 43b of the drive pinion shaft 13. Accordingly, since the teeth and grooves 51a and 51b engage smoothly with the teeth and grooves 43a and 43b, the spacer 51 may be installed easily into the drive pinion shaft 13.

Also, the hardening treatment is applied to the face 51c of the anti-loosening spacer 51 which contacts the inner race 10a of the first bearing for drive pinion 10. Accordingly, the inner race 10a of the first bearing for drive pinion 10 can be prevented from moving axially due to the wear of the face 51c of the anti-loosening spacer 51, and thereby the supporting of the drive pinion shaft 13 can be ensured properly.

Further, the interference of insertion pressure between the inner race 10a of the first bearing for drive pinion 10 and the drive pinion shaft 13 is configured so as to be smaller than that of insertion pressure between the inner race 11a of the second bearing for drive pinion 11 and the drive pinion shaft 13. Accordingly, the frictional resistance generating between the inner race 10a of the first bearing for drive pinion 10 and the drive pinion shaft 13 can be reduced, and thereby the fastening torque of the screw lock nut 50 can be reduced.

It is useful that the present invention is, for example, applied to the support structure of the power transmission shaft for the four-wheel driving vehicle.

However, the present invention should not be limited to the above-described embodiment, but any other modifications and improvements may be applied within the scope of a sprit of the present invention.

1. A support structure of a power transmission shaft in a differential gear for a vehicle, comprising:
a power transmission shaft which is equipped with an input portion for receiving a power at one end thereof and a drive gear for transmitting the power at the other end thereof;
a differential carrier on which said power transmission shaft is supported;
first and second bearings to rotatably support said power transmission shaft on said differential carrier, the first and second bearings being provided in serial order from said one end of the power transmission;
a screw lock nut which is disposed on said power transmission shaft;
an anti-loosening spacer which is disposed on said power transmission shaft between said screw lock nut and an inner race of said first bearing, the anti-loosening spacer being configured so as to be pressed and moved forward on the power transmission shaft by a rotation of said screw lock nut,
wherein said anti-loosening spacer includes a tooth and groove portion which is formed at an inner periphery thereof, said power transmission shaft includes a tooth and grove portion which is formed at an outer periphery thereof so as to engage with said tooth and groove portion of the anti-loosening spacer, and a tooth line of said tooth and groove portion of the anti-loosening spacer and a tooth line of said tooth and groove portion of the power transmission shaft are configured so as to extend in a substantially axial direction of the power transmission shaft but with a specified difference in angle thererbetween, whereby there can exist a specified magnitude of backlash in a rotational direction between the anti-loosening spacer and the power transmission shaft at the beginning of the rotation of said screw lock nut, and said specified magnitude of backlash can be eliminated according to the rotation of the screw lock nut.

2. The support structure of a power transmission shaft in a differential gear for a vehicle of claim 1, wherein an angle of chamfer formed at an end corner of said tooth and groove portion of the anti-loosening spacer is configured so as to be smaller than that formed at an end corner of said tooth and groove portion of the power transmission shaft.

3. The support structure of a power transmission shaft in a differential gear for a vehicle of claim 1, wherein a hardening treatment is applied to a face of said anti-loosening spacer which contacts said inner race of the first bearing.

4. The support structure of a power transmission shaft in a differential gear for a vehicle of claim 1, wherein an interference of insertion pressure between said inner race of the first bearing and said power transmission shaft is configured so as to be smaller than that of insertion pressure between an inner race of said second bearing and said power transmission shaft.

5. The support structure of a power transmission shaft in a differential gear for a vehicle of claim 1, wherein said differential gear for a vehicle comprises a wet multi-plate clutch device to control a distribution ratio of drive power between front wheels and rear wheels of the vehicle, and a power from said wet multi-plate clutch device is transmitted to said input portion of the transmission shaft.
